(19) United States
(12) Patent Application Publication
(10) Pub. No.: US 2021/0163143 A1
(43) Pub. Date: Jun. 3, 2021

(54) AFT ENGINE PYLON FAIRING OF AN AIRCRAFT WITH MULTILAYER HEAT SHIELD

(71) Applicant: Airbus Operations SAS, TOULOUSE (FR)

(72) Inventors: Florent MERCAT, TOULOUSE (FR); Jonathan BLANC, TOULOUSE (FR); Wolfgang BROCHARD, TOULOUSE (FR)

(21) Appl. No.: 17/109,021

(22) Filed: Dec. 1, 2020

(30) Foreign Application Priority Data
Dec. 3, 2019 (FR) 1913646

(51) Int. Cl. B64D 29/00; B64D 27/26; F02C 7/24; B32B 3/26; B32B 5/18; B32B 5/24; B32B 3/12; B32B 9/00; B32B 9/04; B32B 15/04

(52) U.S. Cl. CPC B64D 29/00; B32B 2605/18; F02C 7/24; B32B 3/266; B32B 5/18; B32B 5/245; B32B 3/12; B32B 9/005; B32B 9/046; B32B 15/046; F05D 2260/231; B32B 2262/106; B32B 2307/102; B32B 2307/304; B64D 27/26

(57) ABSTRACT

An aft engine pylon fairing including a framework including lateral panels, transverse reinforcing ribs, and a heat shield linked to the framework. The heat shield has a multilayer structure comprising an insulating core configured both to constitute a thermal barrier and to damp acoustic waves, an outer skin configured to guide an aerodynamic flow and contribute to the acoustic damping, and an inner skin configured to ensure the mechanical strength of the shield. The shield multilayer structure allows the aft engine pylon fairing to contribute to the attenuation of the noise nuisances of the engine, and, also, to improve the thermal insulation conferred by the shield by allowing the use, for the insulating core of the shield, of materials having a better thermal resistance but a low mechanical rigidity, the mechanical strength being essentially ensured by the inner skin of the multilayer structure.

### CROSS-REFERENCES TO RELATED APPLICATIONS

This application claims the benefit of the French patent application No. 1913646 filed on Dec. 3, 2019, the entire disclosures of which are incorporated herein by way of reference.

### FIELD OF THE INVENTION

The present invention relates to the field of aircraft engine attachment pylons (also called simply pylons), hereinafter more succinctly referred to as engine pylon; it relates more specifically to an aft fairing of such an engine pylon.

### BACKGROUND OF THE INVENTION

Throughout the description, a nacelle, an engine or an engine pylon (whether it be a device of the prior art or a device according to the invention) is observed as arranged in an aircraft. The central axis of a nacelle (which coincides with the axis of revolution of the engine that it contains), like the main axis of an engine pylon, being parallel to the roll axis X of the aircraft when the nacelle or the pylon is mounted in the aircraft, the terms “longitudinal direction of a nacelle or pylon or fairing element” designate a direction parallel to the roll axis X of the aircraft; the terms “transverse direction of a nacelle or pylon or fairing element” designate a direction parallel to the yaw axis Y of the aircraft (which corresponds to the axis of the wings of the aircraft); a longitudinal dimension of a nacelle or pylon or fairing element is a dimension of this element according to the axis X; a transverse dimension of a nacelle or pylon or fairing element is a dimension of this element according to the axis Y; a radial dimension of a nacelle element is a dimension of this element according to a radial direction of the engine that it contains (that is to say, according to a direction orthogonal to the axis X). The axis Z designates the axis orthogonal to the axes X and Y, which corresponds to the direction of gravity when the aircraft is resting on flat ground.

An engine pylon allows an engine to be suspended under the wings of the aircraft, an engine to be mounted on top of the same wings, or even this engine to be added in the rear part of the fuselage of the aircraft. The invention can be used on any type of aircraft equipped with turbojet engines or turboprop engines or any other type of engine. The engine pylon is provided to constitute the link interface between an engine (turboshaft, turbojet, turboprop, etc.) and a part of the cell of the aircraft (in particular, the wings). It allows the loads generated by the engine to be transmitted to the primary structure of the aircraft, and also allows for the routing of fuel, of electrical, hydraulic and aeraulic systems, between the engine and the cell of the aircraft.

In order to ensure the transmission of the loads, the engine pylon comprises a rigid primary structure. Moreover, such a pylon is provided with a plurality of secondary structures ensuring the segregation and the securing of the systems while supporting aerodynamic fairing elements, the latter generally taking the form of panel assemblies added onto these secondary structures. As is known to the person skilled in the art, the secondary structures are differentiated from the primary structure of the pylon by the fact that they are not intended to ensure the transfer of the loads originating from the engine and that have to be transmitted to the wings of the aircraft.

Normally, the fairing of an aircraft engine pylon has a front aerodynamic structure, a rear aerodynamic structure called RSS (acronym for “Rear Secondary Structure”), an aerodynamic structure for connecting the front and rear aerodynamic structures, known as “Karman”, and a lower or upper aft aerodynamic fairing, also called “APF” (acronym for “Aft Pylon Fairing”).

The APF ensures a plurality of functions, including the formation of an aerodynamic continuity between the output of the engine and the securing pylon and the formation of a thermal or antifire barrier serving to protect the pylon and the wings from the heat given off by the primary flux from the engine.

It should be noted that the fairing of the pylon adopts a lower position when the engine is intended to be placed under the wing, and it adopts an upper position when the engine is intended to be placed on top of the wing. In the case of an engine placed below the wings, the APF is a lower aft aerodynamic fairing; in the case of an engine placed on top of the wings, the APF is an upper aft aerodynamic fairing.

An example of fairing known from the prior art is disclosed in the document EP 2 644 505. The APF of this fairing comprises a caisson structure formed by two lateral panels joined together by transverse stiffening internal ribs spaced apart from one another in the longitudinal direction, and a thermal protection floor, hereinafter called heat shield.

Because of their location, the lateral panels of the caisson structure of the APF are licked externally by a flow of cold air, such as the secondary flow from the engine when the latter is a dual flow jet engine. Conversely, the heat shield, for its part, has an outer face (lower or upper depending on the location of the engine with respect to the wings) which is licked by a hot flow of combustion gas (or exhaust gas) from the engine, reaching temperatures of the order of 550° C. The heat shield of the APF aims to protect the primary structure of the engine pylon and the systems which are housed therein from the high temperature of the exhaust gases.

The heat shields provided in the known lower aft aerodynamic fairings (APF) all have a monolithic structure. They are formed by a plate of a metallic material such as titanium or a nickel-chromium-based steel (for example an Inconel®), chosen not only for its thermal resistance but also for its rigidity.

With the advent of a new generation of UHBR (“Ultra High Bypass Ratio”) engine, the temperature of the exhaust gases increases to reach temperatures lying between 600° C. and 800° C. Given this increase in the temperature of the exhaust gases, the metal plates used to form the heat shield of the APF serve as a firewall but it would nevertheless be desirable to limit the heat given off by the heat shield in order to lower the temperatures to which the pylon, the systems and the wings in the vicinity of the engine output are exposed.

To this end, it would be possible to consider providing a shield formed by a plate made of a ceramic matrix composite (“CMC”) material, but the mechanical properties of these materials are unsuitable, with a Young's modulus that is too low.

Furthermore, the new generation engines and nacelles are shorter in the longitudinal direction and wider in the radial directions, which results in a shortening of the acoustically treated longitudinal dimension. Sound nuisances from these engines are not sufficiently attenuated by the nacelles of known structures.

### SUMMARY OF THE INVENTION

The invention aims to provide a novel aft aircraft engine pylon fairing that offers a better thermal insulation and that contributes to the attenuation of the sound nuisances from the engine.

To do that, the invention proposes an aft engine pylon fairing, called APF, comprising, on the one hand, a framework including lateral panels and transverse reinforcing ribs, and, on the other hand, a heat shield linked to the framework, characterized in that the heat shield has a multilayer structure comprising an insulating core configured both to constitute a thermal barrier and to damp acoustic waves, an outer skin and an inner skin, the outer skin being configured to guide the aerodynamic flow and contribute to the acoustic damping, the inner skin being configured to ensure the mechanical strength of the heat shield.

The provision of a multilayer structure to form the heat shield has two main advantages.

It makes it possible, on the one hand, to compensate for the fact that the length of the nacelle, and therefore of the acoustically treated nacelle surface, is reduced for the new generation engines, by giving the heat shield an additional acoustic attenuation function. While all the known developments aim essentially to improve the acoustic performance levels of the nacelle panels, the invention proposes to make the aft fairing of the engine pylon contribute to the attenuation of the sound nuisances from the engine.

The provision of a multilayer structure to form the heat shield makes it possible, on the other hand, to improve the thermal insulation conferred by the shield of the APF since it becomes possible to use, in the insulating core of the shield, materials that have a better thermal resistance (than the monolithic metal plates that form the shields of the prior APFs) but a low mechanical rigidity, the mechanical strength being essentially ensured by the inner skin of the multilayer structure of the shield.

According to one possible feature of an APF according to the invention, the outer skin is a perforated resistive skin. Thus, for example, the outer skin can be provided, over at least a part of its surface, with sound absorption holes having diameters of between 0.1 mm and 2.5 mm.

According to a possible feature of an APF according to the invention, the insulating core of the multilayer structure of the heat shield contains at least one thickness with cellular structure.

According to a possible feature of an APF according to the invention, the outer skin of the heat shield is perforated with sound absorption holes, particularly if the core contains a cellular thickness with open cells (for example, a honeycomb).

According to a possible feature of an APF according to the invention, the insulating core of the multilayer structure of the heat shield contains at least one thickness made of a material chosen from among insulating porous materials including thermally insulating foams, including metal foams, cellular structures including honeycombs, ceramic matrix composite materials, organic or metallic, including silicon carbide, carbon and aluminum oxides.

According to a possible feature of an APF according to the invention, the insulating core of the multilayer structure of the heat shield contains several superposed thicknesses (in the thicknesswise direction of the shield, that is to say in the radial directions, or substantially according to the direction Z) made from materials of different kinds and/or of different structures and/or of different compositions and/or of different densities.

According to a possible feature of an APF according to the invention, the insulating core of the multilayer structure of the heat shield contains several blocks of different materials which follow one another in an orbital direction about the central axis of the engine. Thus, for example, the insulating core of the heat shield can comprise a first central block made of a first material, for example a cellular structure such as a honeycomb, and two lateral blocks on either side of this central block, the lateral blocks being made of a second material capable of increasing the rigidity of the heat shield.

According to a possible feature of an APF according to the invention, the inner skin of the heat shield is a monolithic plate made from a material chosen from among metals or metal alloys, including titanium and nickel-chromium-based steels (alloys) known as Inconel®, composite materials including carbon fiber-based materials, ceramic materials including silicon carbide, carbon and aluminum oxides.

According to a possible feature of an APF according to the invention, the inner skin and the outer skin of the shield are extended laterally beyond the insulating core and meet along the longitudinal edges of the shield to enclose the insulating core by forming two (rigid) longitudinal borders.

Several solutions can be envisaged for linking the heat shield to the framework of the APF.

According to a first solution, the inner skin of the shield is provided, on each side of the shield, with a lateral fixing flange which extends parallel to the adjacent lateral panel; each fixing flange is then fixed to the lateral panel by screws or rivets or by bonding, cofirings or welding. Provision can be made for the fixing flange to extend entirely under the ribs of the framework or for it to be inserted between the adjacent lateral panel and a lower portion of the ribs.

According to a second solution, the inner skin of the heat shield is fixed to the ribs, for example to a lower face or to a transverse face of the ribs.

The invention extends to an engine pylon, a propulsive assembly and an aircraft equipped with an aft engine pylon fairing according to the invention.

The invention extends also to an aft engine pylon fairing, characterized in combination by all or some of the features mentioned above and below. In other words, all the possible combinations based on the features described in the present patent application conform to the invention provided that there is no incompatibility between the combined features.

### BRIEF DESCRIPTION OF THE DRAWINGS

The invention, according to an exemplary embodiment, will be clearly understood and its advantages will become more apparent on reading the following detailed description, given in an indicative and nonlimiting manner, with reference to the attached drawings in which:

FIG. 1 is a perspective view of an aircraft equipped with an aft engine pylon fairing according to the invention.

FIG. 2 is a schematic profile view of an engine pylon and its fairing having an APF according to the invention.

FIG. 3 is a perspective schematic view of an APF of the prior art.

FIG. 4 is a perspective schematic view of the (secondary) structure of the prior APF of FIG. 3, the lateral panels being omitted to reveal the transverse reinforcing ribs of this structure.

FIG. 5 is a perspective schematic view of the heat shield of the prior APF of FIGS. 3 and 4.

FIG. 6 is a cross-sectional view in a transverse plane (plane orthogonal to the longitudinal direction of the APF and therefore to the roll axis X of the aircraft) of an APF according to the invention, which illustrates a first embodiment of the fixing of the heat shield to the framework of the APF.

FIG. 7 is a cross-sectional view in a transverse plane of an APF according to the invention, which illustrates a second embodiment of the fixing of the heat shield to the framework of the APF.

FIG. 8 is a cross-sectional view in a transverse plane of an APF according to the invention, which illustrates a third embodiment of the fixing of the heat shield to the framework of the APF.

FIG. 9 is a cross-sectional view in a transverse plane of an APF according to the invention, which illustrates a first embodiment of the insulating core of the heat shield of the APF.

FIG. 10 is a cross-sectional view in a transverse plane of an APF according to the invention, which illustrates a second embodiment of the insulating core of the heat shield of the APF.

FIG. 11 is a cross-sectional view in a transverse plane of an APF according to the invention, which illustrates a third embodiment of the insulating core of the heat shield of the APF.

FIG. 12 is a cross-sectional view in a transverse plane of an APF according to the invention, which illustrates a fourth embodiment of the insulating core of the heat shield of the APF.

The elements that are the same represented in the abovementioned figures are identified by the same numeric references.

### DETAILED DESCRIPTION OF THE PREFERRED EMBODIMENTS

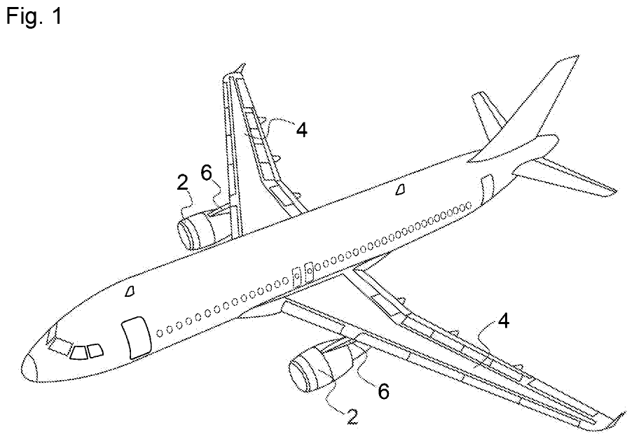

FIG. 1 represents an aircraft. The aircraft comprises two propulsive assemblies (each including an engine, not visible, and a nacelle 2) arranged under the wings 4 of the aircraft, and linked to the wings by engine pylons 6.

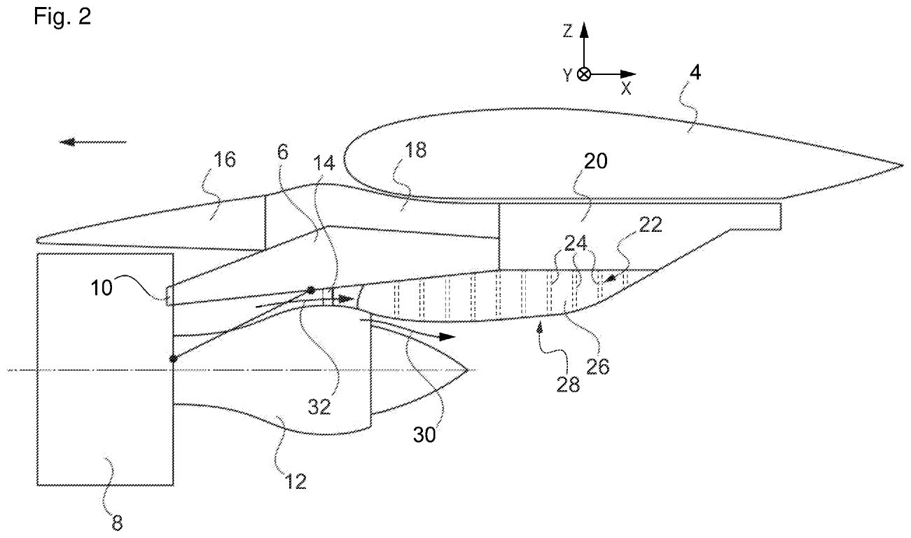

The link between an engine and a wing 4 can be seen in more detail in FIG. 2 (in dotted lines). This link comprises an engine pylon 6 having a primary structure to which the fan casing 8 of the engine is fixed by anterior attachments 10 and to which the central turbine casing 12 is fixed by central attachments 14. The link between the engine and the wing also comprises a fairing including a front aerodynamic structure 16, a rear aerodynamic structure or RSS 20, an intermediate aerodynamic structure or Karman 18, and a lower aft fairing or APF 22.

The APF 22 comprises a framework and a heat shield 28. The framework of the APF comprises reinforcing ribs 24, which extend essentially in transverse planes (planes YZ, orthogonal to the roll axis X) and are spaced apart in the longitudinal direction, and lateral panels 26 which form an aerodynamic structure ensuring a continuity between the engine and the RSS 20 then the wing 4.

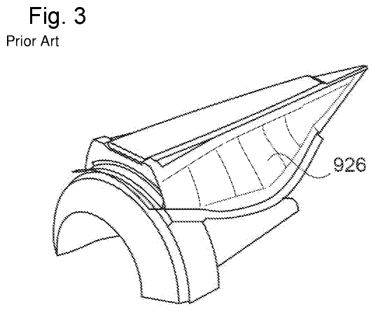

The lateral panels 26 can be formed by flat plates, including one or more flat plates which extend approximately in the longitudinal direction over an anterior portion of the APF, then one or more flat plates which extend in a direction forming an angle with the longitudinal direction over a posterior portion of the APF so that the two lateral panels approach one another toward the rear of the APF. As a variant, the lateral panels are incurved over all their length, like the panels 926 illustrated in FIG. 3.

The heat shield 28 of the APF forms a firewall between the engine and the engine pylon 6, then the wing 4. It is licked by the hot exhaust gases (primary flow) 30 which leave the engine, while the lateral panels 26 of the APF are licked by a colder secondary flow 32.

FIGS. 3 to 5 show an APF of the prior art. A lateral panel 926 can be seen that is curved in FIG. 3, whereas FIG. 4 shows the parts of the framework of the APF which are normally concealed by the lateral panels, in particular the transverse reinforcing ribs 924.

An APF according to the invention can have a framework that is identical or similar to that of the known APFs, in particular ribs 924 like those illustrated in FIGS. 3 and 4. The panels of an APF according to the invention can be panels composed of flat plates or panels with curved face like the panel 926 illustrated in FIG. 3.

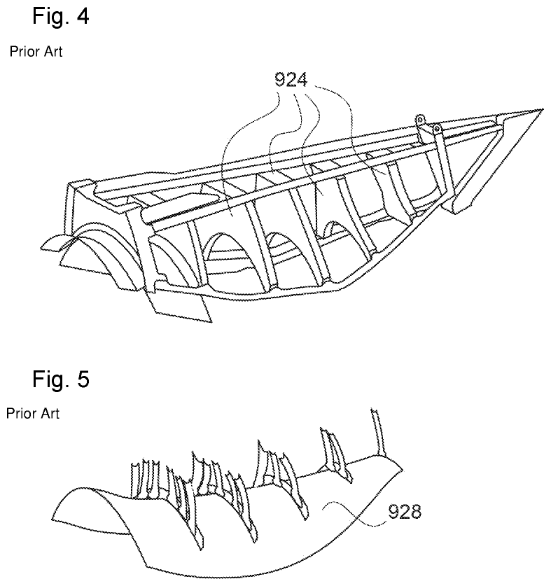

On the other hand, the known APFs all have a monolithic heat shield 928 made of metal, like that illustrated in FIG. 5, while an APF according to the invention has a heat shield 28 with multilayer structure.

This multilayer heat shield can be flat or incurved, with single or double curvature.

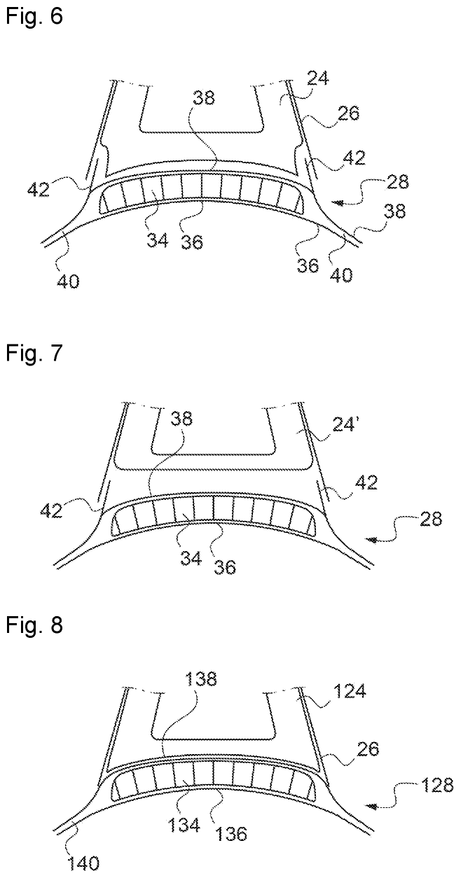

FIGS. 6 to 12 show in more detail heat shields 28, 128, 228, 328, 428 and 528 with multilayer structure according to the invention and the fixing thereof to the framework of the APF.

According to the invention, the heat shield 28 of the APF (see FIG. 6) comprises an insulating core 34, an outer skin 36 and an inner skin 38. The outer skin 36 and the inner skin 38 are extended laterally beyond the insulating core 34, where they meet and are fixed to one another to form two longitudinal borders 40 which enclose the insulating core 34. These borders (also called “blades”) incorporate a thermoaerodynamic function whose objective is to limit the rise of hot air coming from the primary flow and improve the transition of the air flows between the hot air of the primary flow and the cool air of the secondary flow.

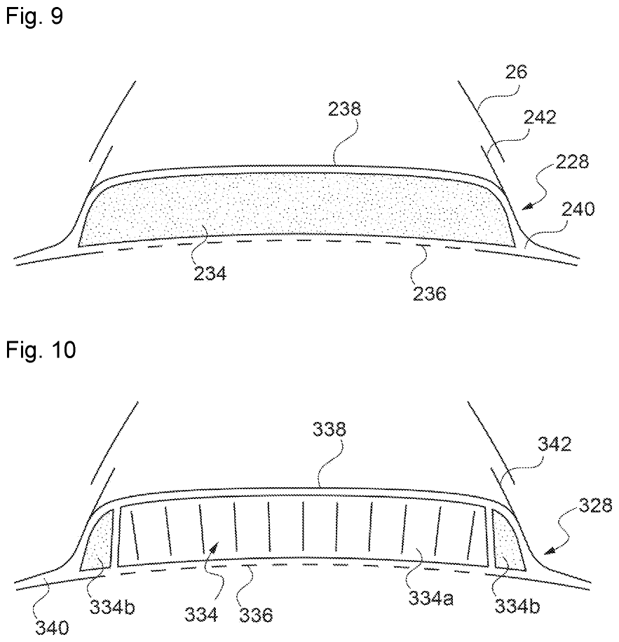

The core 34 of the heat shields illustrated in FIGS. 6 to 8 is composed of a cellular honeycomb structure; another cellular structure, of any section in terms of form and surface area, is of course possible. FIGS. 9 to 12 show other exemplary embodiments of the core of a heat shield with multilayer structure according to the invention.

The core 234 of the shield of FIG. 9 is produced based on an insulating porous material, such as a foam, chosen both for its thermal and acoustic properties, but also mechanical properties. The size of the porosities and the porosity ratio can take various values and, in particular, be adapted according to the acoustic, thermal and structural needs. In particular, the rigidity desired for the shield can determine the chosen foam density, according to the rigidity of the inner skin 238 of the shield. The size and the ratio of the porosities inside the material can vary but will preferably be distributed uniformly. For the remainder of the explanation of the invention, the term foam will generically designate any porous material thus suited to the invention.

The insulating core 334 of the shield of FIG. 10 comprises a cellular central block 334a of cellular structure type (e.g., honeycomb) whose function is essentially to damp the soundwaves. For the remainder of the explanation of the invention, the expression “honeycomb” will generically designate any acoustic cellular material suited to the invention.

In order for this function to be able to be effectively fulfilled (in the case of a honeycomb core for example), the outer skin 336 of the shield is perforated with sound absorption holes facing the block 334a to allow the soundwaves to enter into the honeycomb. The sound absorption holes can vary from 0.1 mm to 2.5 mm in diameter. However, the holes will be as small as possible in order to limit their impact on the drag. Advantageously, these holes have a diameter less than 0.8 mm, preferably less than 0.6 mm, even less than 0.3 mm, for example of the order of 0.1 mm. The holes can have a section of any form, for example circular, oblong, square, polygonal, in droplet form, etc. The “diameter” of the holes then designates the greatest transverse dimension of the holes. The open surface ratio (ratio between the total surface area of the holes to the total surface area of the skin facing the honeycomb) depends on the transverse dimensions of the cells of the honeycomb, on the height of the honeycomb, on the frequency of the waves to be damped, etc. The OSR will be able to be between 3% and 25% depending on the need for acoustic attenuation and on the structural strength required.

The insulating core 334 also comprises two lateral blocks 334b made of foam which contribute to the thermal insulation (but not or not very much to the acoustic insulation) conferred by the shield and whose function is also and above all to rigidify the shield and reinforce the mechanical resistance thereof.

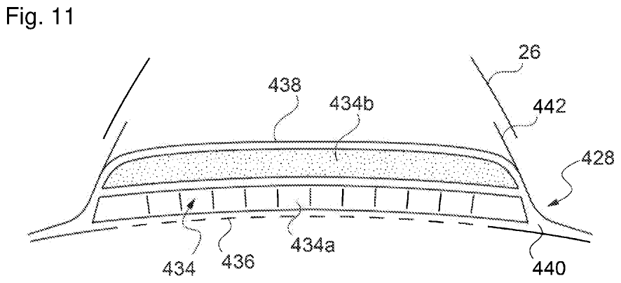

The insulating core 434 of the heat shield 428 of FIG. 11 comprises a first cellular insulating thickness 434a of honeycomb structure type which forms, with the outer skin 436, quarter-wave resonators for the damping of the soundwaves produced by the engine, and a second insulating thickness 434b made of foam which contributes to the thermal insulation (the insulating core forming a thermally insulating mat between the engine and the engine pylon) and which also rigidifies the shield. The foam of the block 434b can have acoustic properties or have none thereof. Unlike the blocks 334a and 334b described previously, the insulating thicknesses 434a and 434b extend over all the width (or circumference) of the shield, apart from two longitudinal borders 440 (which enclose the insulating core); the insulating thicknesses are superposed in a radial direction, that is to say, in the thicknesswise direction of the shield.

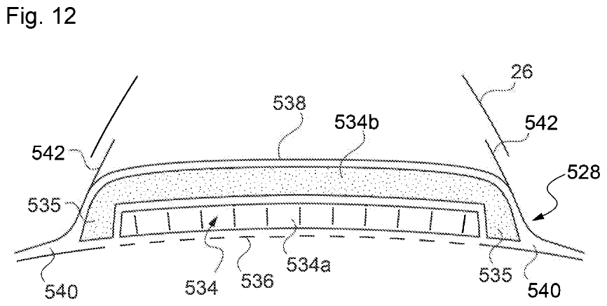

FIG. 12 shows another example of heat shield 534 according to the invention combining two blocks of different cellular materials, one block 534a in honeycomb form and one block 534b made of foam. The acoustic function is essentially ensured by the block 534a which is associated with a perforated resistive outer skin 536. However, the foam used for the block 534b can also have acoustic properties and contribute to the attenuation of the sound nuisances of the engine, although its functions are primarily to improve the mechanical strength of the shield while contributing to the thermal insulation. The two blocks 534a and 534b form two insulating thicknesses that are superposed in radial directions over most of the width of the shield. On each side of the shield, the block of foam 534b also has a brim 535 which forms a lateral reinforcing strip between the honeycomb block 534a and a longitudinal border 540 of the shield. For a better rigidity of the shield, the outer skin 536 is perforated only facing the honeycomb block 534a and is solid facing the lateral reinforcing strips 535 (notably if the foam of the block 534b is not an “acoustic foam”).

The insulating cores illustrated are only nonlimiting examples. All combinations, superpositions and assemblies of blocks of different insulator materials are possible according to the mechanical needs and according to the thermal and acoustic needs, notably as a function of the geometry and of the dimensions of the shield and of the acoustic surface necessary to mitigate an inadequate acoustic treatment of the nacelle of the engine. It is also possible to provide an insulating core whose composition or properties vary in the longitudinal direction; for example, the insulating core contains a block of foam whose density varies in the longitudinal direction or it contains several blocks of different materials which follow one another in the longitudinal direction.

Like the shield 28 of FIG. 6, the shields 128, 228, 328, 428 and 528 comprise longitudinal borders 140, 240, 340, 440, 540.

The shield 28 of FIGS. 6 and 7 also comprises two lateral fixing flanges 42 which each extend parallel to the adjacent lateral panels 26 from the inner skin 38 of the shield. These lateral flanges are used to assemble the shield and the framework of the APF. They can, in fact, be fixed onto the lateral panels 26, against which they are pressed, by brazing, cofiring, welding or bonding or even using rivets or screws. Similarly, the shields 228, 328, 428, 528 of FIGS. 9 to 12 are provided with lateral fixing flanges 242, 342, 442, 542.

In the example of FIG. 7, the lateral fixing flanges 42 extend entirely under the ribs 24′ of the framework. Conversely, in the example of FIG. 6, each rib 24 has, on each side of the APF, a lateral face which runs along the adjacent lateral panel 26. A shoulder is formed in the lateral face of the rib so that a space is created between the rib 24 and the lateral panel 26 over a lower portion of the rib. An upper portion of the fixing flange 42 of the shield is inserted into the space between the rib and the lateral panel.

FIG. 8 illustrates a variant in which the shield 128 has no lateral fixing flanges. In this variant, the inner skin 138 of the shield is pressed against a lower face of the ribs 124 of the framework and the inner skin 138 is fixed onto the lower face of the ribs 124, for example by bonding or welding (the lateral panels 26 of the framework are in this case fixed to the ribs 124 after the fixing of the shield 128 to the ribs); as a variant, the inner skin 138 is provided with fixing tabs (like those that can be seen on the monolithic anterior shield of FIG. 5 and each tab is fixed onto a transverse face of a rib 124 using screws or by bonding or welding.

Obviously, other fixing methods are possible. It is, for example, possible to envisage using longitudinal borders 40, 140, etc., by fixing the latter to the lateral panels 26 of the framework of the APF, the core of the shield then being dimensioned so as to be inserted fully into the framework between the two lateral panels; the fixing can then be obtained using screws or rivets either via splice plates or directly (in this case, a rim extending parallel to the adjacent border is provided in each of the lateral panels; as a variant, the rim is formed in the border of the shield and extends parallel to the adjacent lateral panel).

The invention extends to any variant accessible to the person skilled in the art, that is to say, to any variant falling within the scope delimited by the attached claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aft engine pylon fairing for an engine comprising:
a framework including lateral panels and transverse reinforcing ribs, and
a heat shield linked to the framework,
the heat shield having a multilayer structure comprising
an insulating core configured both to constitute a thermal barrier and to damp acoustic waves,
an outer skin and an inner skin,
the outer skin being configured to guide an aerodynamic flow and contribute to acoustic damping,
the inner skin being configured to ensure a mechanical strength of the heat shield,
the inner skin and the outer skin of the heat shield being extended laterally beyond the insulating core and meeting along longitudinal edges of the shield to enclose the insulating core by forming two longitudinal borders.

2. The aft engine pylon fairing according to claim 1, wherein the outer skin is a perforated resistive skin.

3. The aft engine pylon fairing according to claim 2, wherein the outer skin is provided, on at least a part of its surface, with sound absorption holes having diameters of between 0.1 mm and 2.5 mm.

4. The aft engine pylon fairing according to claim 1, wherein the insulating core of the multilayer structure of the heat shield contains at least one thickness made of a material chosen from among insulating porous materials including thermally insulating foams including metal foams, cellular structures including honeycombs, ceramic matrix composite materials, organic or metallic, including silicon carbide, carbon and aluminum oxides.

5. The aft engine pylon fairing according to claim 1, wherein the insulating core of the multilayer structure of the heat shield contains several superposed thicknesses made from materials of at least one of different kinds, different structures, different compositions or different densities.

6. The aft engine pylon fairing according to claim 1, wherein the insulating core of the multilayer structure of the heat shield contains several blocks of different materials which follow one another in an orbital direction about a central axis of the engine.

7. The aft engine pylon fairing according to claim 6, wherein the insulating core of the multilayer structure of the heat shield contains at least one central block with cellular structure and two lateral blocks on either side of the central block, the lateral blocks being made of a second material capable of increasing a rigidity of the heat shield.

8. The aft engine pylon fairing according to claim 1, wherein the inner skin of the heat shield is a monolithic plate made from a material chosen from among metals or metal alloys, including titanium and nickel-chromium-based steels known as Inconel®, composite materials including carbon fiber-based materials, ceramic materials including silicon carbide, carbon and aluminum oxides.

9. The aft engine pylon fairing according to claim 1, wherein the inner skin of the heat shield is provided, on each side of the heat shield, with a lateral fixing flange which extends parallel to the lateral panel on the side concerned, and wherein each lateral fixing flange is fixed to the lateral panel which is adjacent to such lateral fixing flange.

10. The aft engine pylon fairing according to claim 1, wherein the inner skin of the heat shield is fixed to the transverse reinforcing ribs of the framework.

11. An aircraft engine pylon, comprising an aft engine pylon fairing according to claim 1.

12. An aircraft comprising an aft engine pylon fairing according to claim 1.
